(19) United States
(12) Patent Application Publication
(10) Pub. No.: US 2026/0297767 A1
(43) Pub. Date: Oct. 1, 2026

(54) ELECTROLYSIS CELL

(71) Applicants: HONDA MOTOR CO., LTD., TOKYO (JP); De Nora Permelec Ltd, FUJISAWA-SHI (JP)

(72) Inventors: Minoru GOTO, WAKO-SHI (JP); Hideo OTSU, FUJISAWA-SHI (JP); Koji YOSHIMURA, FUJISAWA-SHI (JP)

(21) Appl. No.: 19/574,705

(22) Filed: Mar. 23, 2026

(30) Foreign Application Priority Data
Mar. 25, 2025 (JP) 2025-049253

(51) Int. Cl. C25B 9/23; C25B 9/65; C25B 11/03

(52) U.S. Cl. CPC C25B 9/23; C25B 9/65; C25B 11/03

(57) ABSTRACT

An electrolysis cell includes: a band-shaped stacked body including a diaphragm including a first surface and a second surface, a cathode stacked on the first surface of the diaphragm, and an anode stacked on the second surface of the diaphragm, the stacked body meandering in a first direction and extending in a second direction; a first current collector that extends in a rod shape in a third direction perpendicular to the first direction and the second direction, and abuts on the cathode at a first curved portion where the stacked body is curved such that the first surface is located on the inner side; and a second current collector that extends in a rod shape in the third direction, and abuts on the anode at a second curved portion where the stacked body is curved such that the second surface is located on the inner side.

### CROSS-REFERENCE TO RELATED APPLICATIONS

This application is based upon and claims the benefit of priority from Japanese Patent Application No. 2025-049253 filed on Mar. 25, 2025, the contents of which are incorporated herein by reference.

### BACKGROUND OF THE INVENTION

### Field of the Invention

The present disclosure relates to an electrolysis cell for electrolyzing water to generate hydrogen.

### Description of the Related Art

In recent years, research and development has been conducted on hydrogen production by water electrolysis that contributes to energy efficiency in order to ensure that more people have access to affordable, reliable, sustainable and modern energy (for example, JP 6803406 B2).

### SUMMARY OF THE INVENTION

In the technology relating to water electrolysis, attention is being focused on alkaline water electrolysis methods that can utilize inexpensive catalysts. In the alkaline water electrolysis method, a filter press type device in which a plurality of flat plate-shaped electrodes and diaphragms are stacked is widely adopted, but there is a problem that the structure is complicated and the installation cost is high. In addition, the filter press type device has a problem that the generated gas is likely to remain inside a porous metal material that is used for supplying a current to the electrodes.

In order to solve the above problem, an object of the present disclosure is to simplify the device configuration in the alkaline water electrolysis method and reduce the installation cost. This contributes to energy efficiency.

An aspect of the present disclosure is characterized by an electrolysis cell comprising: a stacked body having a band shape and including a diaphragm including a first surface and a second surface, a cathode stacked on the first surface of the diaphragm, and an anode stacked on the second surface of the diaphragm, the stacked body meandering in a first direction and extending in a second direction; a first current collector extending in a rod shape in a third direction perpendicular to the first direction and the second direction, and configured to abut on the cathode at a first curved portion where the stacked body is curved in a manner so that the first surface is located on an inner side; and a second current collector extending in a rod shape in the third direction, and configured to abut on the anode at a second curved portion where the stacked body is curved in a manner so that the second surface is located on an inner side.

According to the electrolysis cell of the present disclosure, a porous metal material required for a filter press type electrolysis cell is not required, and the structure can be simplified. In addition, in the above-described electrolysis cell, the retention of the gas can be suppressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a cross-sectional view of an electrolysis cell according to a first embodiment;

FIG. 2 is a cross-sectional view of a stacked body in FIG. 1;

FIG. 3 is a perspective view of the electrolysis cell in FIG. 1;

FIG. 4 is a cross-sectional view of an electrolysis cell according to a modification of the first embodiment;

FIG. 5A is an explanatory view showing a problem in the case of using soft meshed metal for electrodes (an anode and a cathode);

FIG. 5B is an enlarged cross-sectional view of a portion surrounded by a one dot chain line VB in FIG. 5A;

FIG. 6A is a cross-sectional view showing a method for manufacturing a stacked body according toa second embodiment;

FIG. 6B is a cross-sectional view of an electrolysis cell according to the second embodiment; and

FIG. 7 is a graph showing measurement results of surface pressures of stacked bodies according to Experimental Example 1, Experimental Example 2, and Experimental Example 3.

### DETAILED DESCRIPTION OF THE INVENTION

### First Embodiment

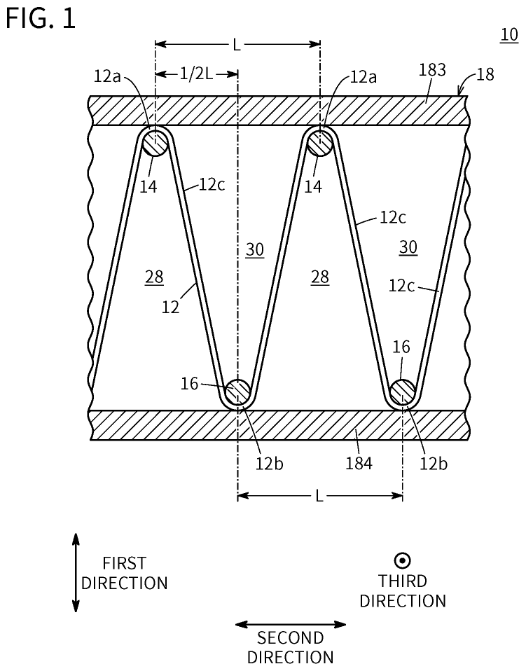

As shown in FIG. 1, an electrolysis cell 10 according to a first embodiment includes a stacked body 12, a first current collector 14, a second current collector 16, and a housing 18. The stacked body 12 is formed in a band shape having a constant width in a third direction perpendicular to the paper surface of FIG. 1, and is shaped so as to meander by a plurality of the first current collectors 14 and a plurality of the second current collectors 16 and is supported by them.

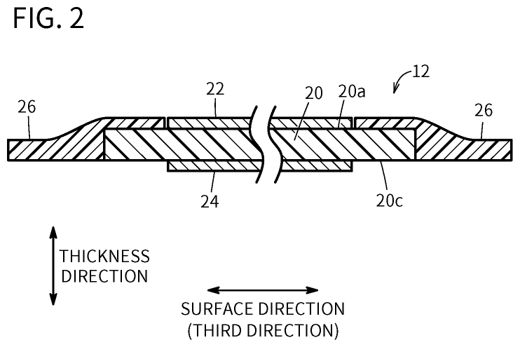

As shown in FIG. 2, the stacked body 12 includes a diaphragm 20, a cathode 22, an anode 24, and a seal member 26. Note that, in FIG. 2, a direction along a plane of the diaphragm 20 is referred to as a surface direction, and a direction perpendicular to the plane of the diaphragm 20 is referred to as a thickness direction. The thickness direction in FIG. 2 does not necessarily coincide with a first direction and a second direction in FIG. 1. On the other hand, the surface direction in FIG. 2 substantially coincides with the third direction (for example, the vertical direction) in FIG. 1.

The diaphragm 20 is formed of a flexible resin sheet that has ionic conductivity for allowing OH⁻ ions to pass therethrough and prevents the movement of oxygen gas and hydrogen gas. Specific materials of the diaphragm 20 are also described in, for example, JP 6803406 B2.

The diaphragm 20 includes a first surface 20a on one side in the thickness direction, and a second surface 20c on the other side in the thickness direction. The cathode 22 is disposed on the first surface 20a of the diaphragm 20. The cathode 22 is formed by, for example, attaching a catalyst to the surface of a metal substrate made of meshed metal, expanded metal, or the like. The metal substrate of the cathode 22 is, for example, nickel or a nickel alloy. Note that the materials of the cathode 22 and the catalyst thereof may be, for example, materials listed in JP 6803406 B2.

The anode 24 is disposed on the second surface 20c of the diaphragm 20. The anode 24 is disposed on the opposite side of the diaphragm 20 to the cathode 22. The anode 24 is configured in the same manner as the cathode 22, and meshed metal or expanded metal of nickel or a nickel alloy is used for the anode 24, for example. The materials of the metal substrate and the catalyst of the anode 24 may be, for example, materials listed in JP 6803406 B2.

End portions of each of the cathode 22 and the anode 24 in the surface direction are located on the inner side of end portions of the diaphragm 20 in the surface direction. Therefore, in the vicinity of both ends of the diaphragm 20 in the surface direction, the first surface 20a is exposed from the cathode 22, and the second surface 20c is exposed from the anode 24.

The seal member 26 is joined to either the first surface 20a or the second surface 20c of a portion of the diaphragm 20 that is not covered with the anode 24 or the cathode 22. In the illustrated example, the seal member 26 is joined to the first surface 20a by a method such as bonding or welding. The seal member 26 is joined to both end portions of the diaphragm 20 in the surface direction.

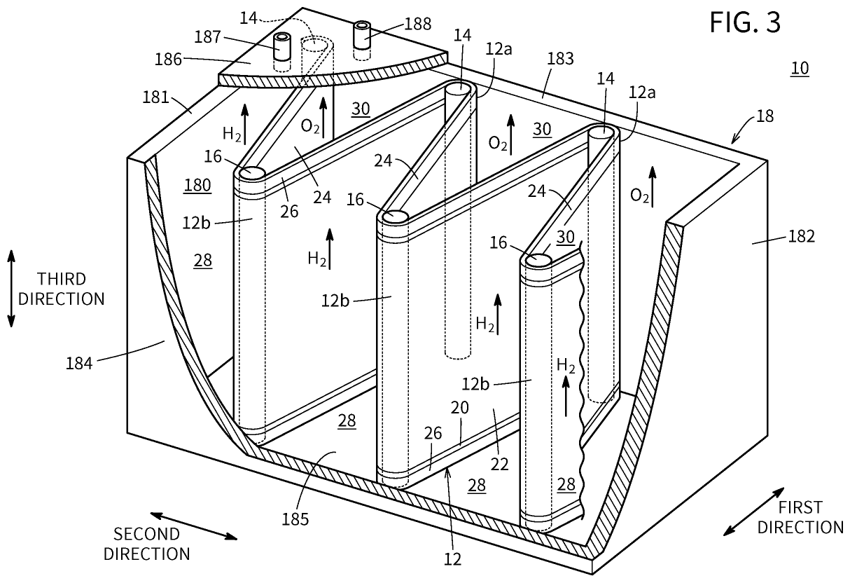

The seal member 26 is provided to prevent mixing of oxygen gas generated on the anode 24 side and hydrogen gas generated on the cathode 22 side. The seal member 26 is formed of a flexible resin sheet that does not allow hydrogen gas and oxygen gas to permeate therethrough. End portions of the seal member 26 in the surface direction are respectively joined to a bottom surface portion 185 and an upper surface portion 186 of the housing 18 shown in FIG. 3. The diaphragm 20 and the seal member 26 partition the inside of the housing 18 into first gas flow paths 28 and second gas flow paths 30 in an airtight manner.

As shown in FIG. 1, the stacked body 12 is formed in a triangular wave (corrugated) shape so as to meander in the first direction and extend in the second direction when viewed from the third direction. In order to maintain such a shape, the stacked body 12 is supported by the first current collectors 14 and the second current collectors 16. The stacked body 12 includes a first curved portion 12a that is bent such that the first surface 20a of the diaphragm 20 is located on the inner peripheral side, a second curved portion 12b that is bent such that the second surface 20c of the diaphragm 20 is located on the inner peripheral side, and a straight portion 12c that extends between the first curved portion 12a and the second curved portion 12b. The stacked body 12 between the first curved portion 12a and the second curved portion 12b is pulled by the tension acting between the first current collector 14 and the second current collector 16, and forms a flat plane.

A part of the tension acting in the planar direction of the stacked body 12 generates, at the straight portion 12c, a surface pressure in a direction in which the cathode 22 and the anode 24 are pressed against the diaphragm 20. In the electrolysis cell 10 of the present embodiment, the diaphragm 20, the cathode 22, and the anode 24 come into close contact with each other by the tension acting between the first curved portion 12a and the second curved portion 12b. It should be noted that, when the inclination angle of the straight portion 12c with respect to the second direction when viewed from the third direction is 90 degrees, that is, when the straight portion 12c is parallel to the first direction, the surface pressure between the cathode 22 and the diaphragm 20 and between the anode 24 and the diaphragm 20 extremely decreases, the electric resistance increases, and the inter-electrode voltage increases. Therefore, the straight portion 12c is preferably inclined obliquely with respect to the second direction. However, if the inclination angle is too small, the dimension in the second direction per cycle of the meandering increases, and the areas of the cathode 22 and the anode 24 per floor area of the electrolysis cell 10 decrease. Although not particularly limited, it is preferable that the straight portion 12c of the stacked body 12 is inclined at an angle of about 60 degrees with respect to the second direction.

The first current collector 14 and the second current collector 16 are circular columnar or cylindrical metal members extending in a rod shape in the third direction, and are formed of, for example, metal (conductor) having alkali resistance such as stainless steel.

As shown in FIG. 1, the first current collector 14 is disposed at the first curved portion 12a, and abuts on the stacked body 12 from the inner peripheral side of the first curved portion 12a to support the stacked body 12. The first current collector 14 is in electrical contact with the cathode 22 at the first curved portion 12a, and supplies a current to the cathode 22. A plurality of the first current collectors 14 are provided at a constant pitch L in the second direction.

The second current collector 16 is disposed at the second curved portion 12b, and abuts on the stacked body 12 from the inner peripheral side of the second curved portion 12b to support the stacked body 12. The second current collector 16 is in electrical contact with the anode 24 at the second curved portion 12b, and supplies a current to the anode 24.

The second current collector 16 is disposed at a position separated from the first current collector 14 in the first direction by a predetermined distance. A plurality of the second current collectors 16 are provided at the constant pitch L in the second direction. The second current collector 16 is disposed to be shifted from the first current collector 14 by a ½ pitch (½ L) in the first direction.

As shown in FIG. 3, the first current collectors 14 and the second current collectors 16 are fixed to the bottom surface portion 185 and the upper surface portion 186 of the housing 18. The housing 18 may include a tension adjustment mechanism capable of displacing the first current collectors 14 and the second current collectors 16 in the second direction in order to adjust the tension applied to the stacked body 12.

The housing 18 is configured as a box-shaped container surrounding the peripheries of the stacked body 12, the first current collectors 14, and the second current collectors 16. The housing 18 includes a first side wall 181 and a second side wall 182 that extend parallel to the first direction and the third direction, a third side wall 183 and a fourth side wall 184 that extend parallel to the second direction and the third direction, the bottom surface portion 185 covering the lower portion, and the upper surface portion 186 covering the upper portion. A volume portion 180 for storing an alkaline aqueous solution is formed inside the housing 18.

The first side wall 181 and the second side wall 182 are disposed adjacent to end portions of the stacked body 12 in the first direction. One end portion of the stacked body 12 in the first direction is joined to the first side wall 181, and the other end portion of the stacked body 12 in the first direction is joined to the second side wall 182.

The third side wall 183 is disposed adjacent to the plurality of first curved portions 12a. The second gas flow paths 30 each having a triangular cross section when viewed from the third direction are formed between the third side wall 183 and the stacked body 12. Bubbles of oxygen gas generated by electrolysis of water flow through the second gas flow path 30. The fourth side wall 184 is disposed adjacent to the plurality of second curved portions 12b. The first gas flow paths 28 each having a triangular cross section when viewed from the third direction are formed between the fourth side wall 184 and the stacked body 12. Bubbles of hydrogen gas generated by electrolysis of water flow through the first gas flow path 28.

The bottom surface portion 185 and the upper surface portion 186 are formed along a plane perpendicular to the third direction. The seal member 26 extending from the stacked body 12 is joined to the bottom surface portion 185 and the upper surface portion 186. The bottom surface portion 185 and the upper surface portion 186 are provided with support members that support the first current collectors 14 and the second current collectors 16. A hydrogen port 187 for discharging hydrogen gas is formed in a portion of the upper surface portion 186 that communicates with the first gas flow path 28. Further, an oxygen port 188 for discharging oxygen gas is formed in a portion of the upper surface portion 186 that communicates with the second gas flow path 30.

Note that the third side wall 183 and the fourth side wall 184 are not in electrical contact with the stacked body 12.

The electrolysis cell 10 of the present embodiment is configured as described above. In the electrolysis cell 10 of the present embodiment, since a porous metal material is not required in the first gas flow path 28 and the second gas flow path 30, the flow of the generated gas is not hindered, and the gas is prevented from remaining inside the housing 18.

In addition, in the electrolysis cell 10, the area of the electrodes can be increased by meandering them without stacking bipolar plates or the like, and therefore, the number of members required per electrode area is reduced, and the device configuration is simplified. As a result, the installation and maintenance costs of the electrolysis cell 10 are reduced. In addition, since the electrode area per predetermined floor area is large, the amount of current (current density) per electrode area can be reduced, leading to an excellent power utilization efficiency.

### Modification of First Embodiment

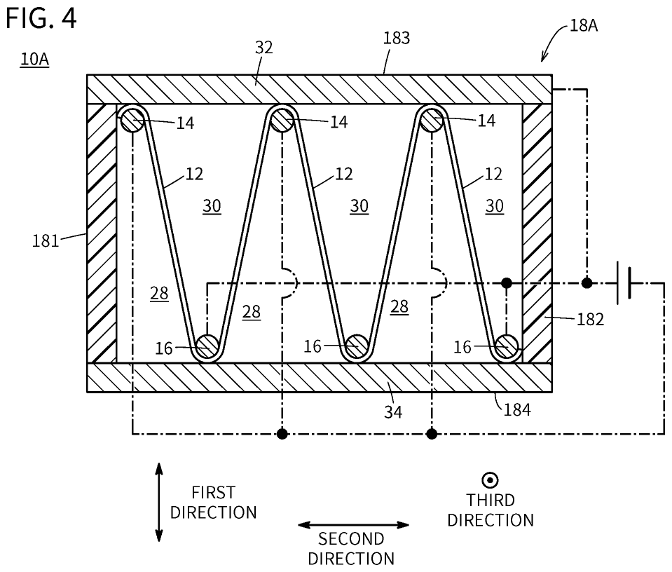

In an electrolysis cell 10A of the present modification, as shown in FIG. 4, the third side wall 183 of a housing 18A constitutes a first auxiliary current collector 32, and the fourth side wall 184 constitutes a second auxiliary current collector 34. The first side wall 181 and the second side wall 182, and the bottom surface portion 185 and the upper surface portion 186 (see FIG. 3) not shown in FIG. 4 are electrically insulated from the third side wall 183, the fourth side wall 184, and the stacked body 12.

The first auxiliary current collector 32 abuts on the plurality of first curved portions 12a from the outer peripheral side. The first auxiliary current collector 32 is electrically connected to the anode 24 and the second current collectors 16, and supplies a current to the anode 24 in cooperation with the second current collectors 16. The second auxiliary current collector 34 abuts on the plurality of second curved portions 12b from the outer peripheral side. The second auxiliary current collector 34 is electrically connected to the cathode 22 and the first current collectors 14, and supplies a current to the cathode 22 in cooperation with the first current collectors 14.

In the electrolysis cell 10A configured in this manner, the distance over which the current is supplied along the surface direction of the cathode 22 and the anode 24 is shorter than in the case of FIG. 1, and the internal resistance can be reduced. Further, by stacking a plurality of the electrolysis cells 10A in the first direction, the electrolysis cells 10A can be connected in series, and the scalability is excellent.

### Second Embodiment

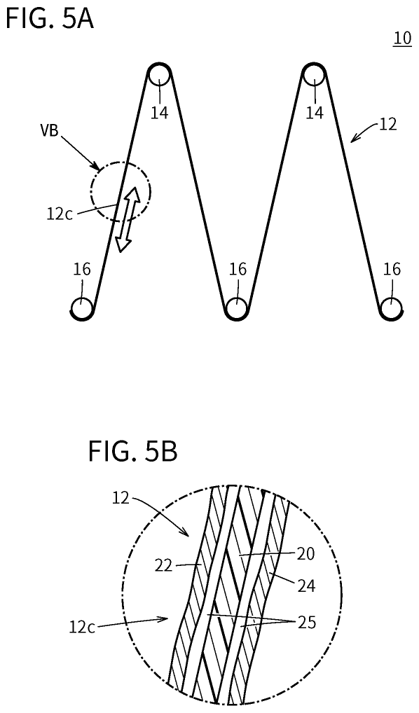

As shown in FIG. 5A, it was found that, when thin and fine meshed metal is fixed only by the tension in the electrolysis cell 10, the adhesion between the cathode 22 and the diaphragm 20 and between the anode 24 and the diaphragm 20 is reduced at the straight portion 12c of the stacked body 12. When the adhesion between the cathode 22 and the diaphragm 20 and between the anode 24 and the diaphragm 20 is reduced, a minute gap 25 is formed between the diaphragm 20 and the electrode (the cathode 22 or the anode 24) as shown in FIG. 5B. The electrolyte solution flows into the gap 25 or the gap 25 causes the diaphragm 20 to swell, whereby the internal resistance is increased. As a result, the stacked body 12 having a reduced adhesion increases the current density during electrolysis, thereby increasing the electrolysis voltage. The increase in the electrolysis voltage becomes energy that is not used for the electrolysis of water, thereby reducing the electrolysis efficiency.

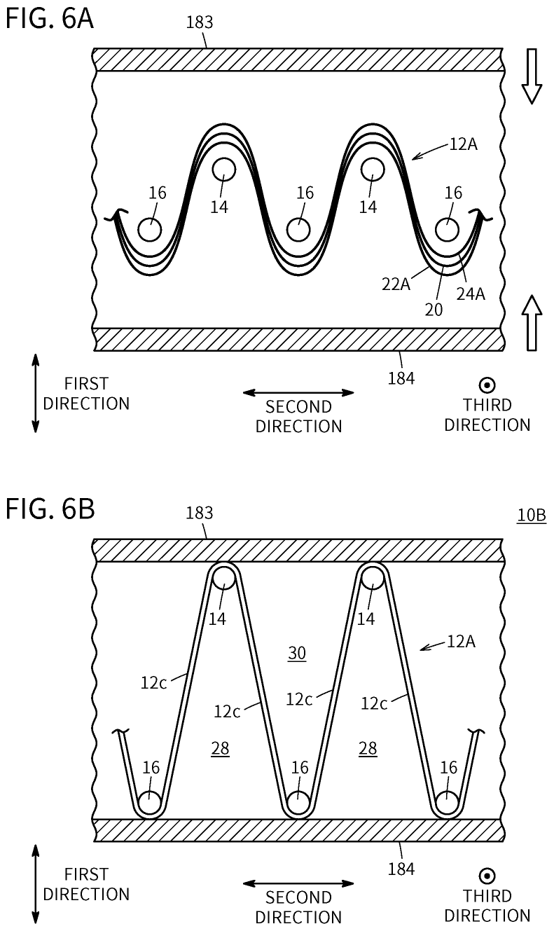

Therefore, in the present embodiment, as shown in FIG. 6A, a material having high rigidity is used for a cathode 22A and an anode 24A that constitute a stacked body 12A. The cathode 22A and the anode 24A are each formed by, for example, attaching a catalyst to the surface of a metal substrate formed of nickel expanded metal. It should be noted that the cathode 22A and the anode 24A are not limited to being formed of the expanded metal, and may be formed to contain nickel punching metal, thick meshed nickel, or the like capable of maintaining a shape formed into a corrugated shape. The cathode 22A and the anode 24A of the present embodiment are formed in a corrugated shape in advance as shown in the figure.

An electrolysis cell 10B of the present embodiment is obtained by preparing the cathode 22A and the anode 24A which are formed into a corrugated shape in advance, and disposing the diaphragm 20 therebetween to stack the cathode 22A, the diaphragm 20, and the anode 24A. Thereafter, by pressing them in the stacking direction (the first direction) with the third side wall 183 and the fourth side wall 184 of the housing 18, the electrolysis cell 10B is formed. As shown in FIG. 6B, in the electrolysis cell 10B of the present embodiment, the diaphragm 20 can reliably come into close contact with the cathode 22A and the anode 24A even at the straight portion 12c by the elastic forces of the cathode 22A and the anode 24A. This suppresses an increase in the electrolysis voltage due to a decrease in the adhesion between the electrodes and the diaphragm 20.

### Experimental Example 1

In Experimental Example 1, meshed nickel having a thickness of 0.18 mm and an opening size of 1 mm was used for the cathode 22 and the anode 24, a tension was applied to the stacked body 12 in the structure shown in FIG. 1, and the surface pressure generated at the straight portion 12c of the stacked body 12 was measured. The surface pressure generated in Experimental Example 1 was 14.6 kPa.

### Experimental Example 2

In Experimental Example 2, the same meshed nickel as in Experimental Example 1 was used for the cathode 22A and the anode 24A. The cathode 22A and the anode 24A were formed in a corrugated shape in advance as shown in FIG. 6A, and cathode 22A, the anode 24A, and the diaphragm 20 are stacked so that the diaphragm 20 is sandwiched between the cathode 22A and the anode 24A, to form the stacked body 12. A load was applied to the stacked body 12 through the third side wall 183 and the fourth side wall 184 so as to sandwich the stacked body 12 in the first direction.

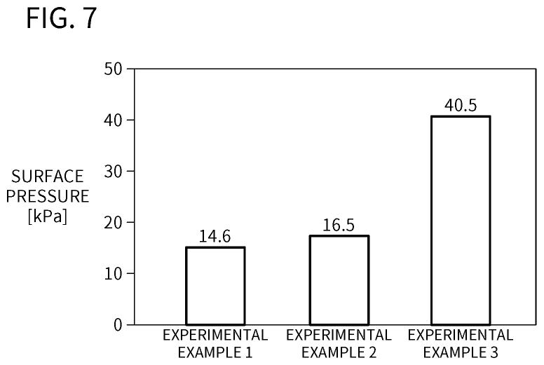

Thereafter, the surface pressure of the straight portion 12c of the stacked body 12 was measured. As shown in FIG. 7, in Experimental Example 2, a surface pressure of 16.5 kPa was obtained, and the surface pressure was improved as compared with Experimental Example 1.

### Experimental Example 3

In Experimental Example 3, nickel expanded metal having a thickness of 0.75 mm and a diamond opening with an opening size of 4 mm height and 8 mm width was used for the cathode 22A and the anode 24A. The cathode 22A and the anode 24A were formed into a corrugated shape in advance, and then overlapped with the diaphragm 20 to form the stacked body 12. Thereafter, the stacked body 12 was pressed in the first direction from the third side wall 183 and the fourth side wall 184, and the surface pressure of the straight portion 12c was measured. As shown in FIG. 7, in Experimental Example 3, a surface pressure of 40.5 kPa was obtained. This surface pressure is substantially equivalent to that of the conventional filter press type electrolysis cell. Therefore, it was confirmed that using the expanded metal formed in a corrugated shape for the cathode 22A and the anode 24A is effective for improving the electrolytic performance.

The following supplementary notes are further disclosed in relation to the above-described embodiments.

### Supplementary Note 1

The electrolysis cell (10, 10A, 10B) of the present disclosure includes: the stacked body (12, 12A) having a band shape and including the diaphragm (20) including the first surface (20a) and the second surface (20c), the cathode (22, 22A) stacked on the first surface of the diaphragm, and the anode (24, 24A) stacked on the second surface of the diaphragm, the stacked body meandering in the first direction and extending in the second direction; the first current collector (14) extending in a rod shape in the third direction perpendicular to the first direction and the second direction, and configured to abut on the cathode at the first curved portion (12a) where the stacked body is curved in a manner so that the first surface is located on the inner side; and the second current collector (16) extending in a rod shape in the third direction, and configured to abut on the anode at the second curved portion (12b) where the stacked body is curved in a manner so that the second surface is located on the inner side.

This electrolysis cell does not require a porous metal material, and is therefore simplified in structure. Further, the gas can be prevented from remaining in the gas flow path.

### Supplementary Note 2

In the electrolysis cell according to Supplementary Note 1, the first current collector and the second current collector may create a tension in the stacked body to bring the cathode and the anode into close contact with the diaphragm. This electrolysis cell can be simplified in structure.

### Supplementary Note 3

In the electrolysis cell according to Supplementary Note 1 or 2, the stacked body may include the straight portion (12c) extending between the first curved portion and the second curved portion adjacent to the first curved portion so as to be inclined with respect to the first direction and the second direction. In this electrolysis cell, the cathode and the anode can come into close contact with the diaphragm by the tension of the stacked body 12.

### Supplementary Note 4

In the electrolysis cell according to Supplementary Note 1, the cathode and the anode may be formed into a corrugated shape, and have rigidity to maintain the corrugated shape, and the stacked body may be compressed from both sides thereof in the first direction to bring the cathode and the anode into close contact with the diaphragm by elastic forces of the cathode and the anode. In this electrolysis cell, a higher surface pressure can be generated between the anode and the diaphragm and between the cathode and the diaphragm than in the case where only the tension acts thereon. The increase in the surface pressure reduces the resistance component derived from the minute gap between the anode and the diaphragm and between the cathode and the diaphragm.

### Supplementary Note 5

In the electrolysis cell according to Supplementary Note 4, the cathode and the anode may come into close contact with the diaphragm by a tension caused by the first current collector and the second current collector in addition to the elastic forces of the cathode and the anode. In this electrolysis cell, the anode and the cathode can more effectively come into close contact with the diaphragm.

### Supplementary Note 6

In the electrolysis cell according to Supplementary Note 4 or 5, the cathode and the anode may each include expanded metal. This electrolysis cell is excellent in rigidity of the cathode and the anode.

### Supplementary Note 7

In the electrolysis cell according to Supplementary Note 1, the stacked body may define, on the inner side of the first curved portion, the first gas flow path (28) through which a gas generated at the cathode passes, and may define, on the inner side of the second curved portion, the second gas flow path (30) through which a gas generated at the anode passes.

### Supplementary Note 8

In the electrolysis cell according to Supplementary Note 7, the first gas flow path and the second gas flow path may each have a triangular cross section when viewed from the third direction.

### Supplementary Note 9

In the electrolysis cell according to Supplementary Note 7 or 8, the cathode and the anode may each be formed of meshed metal.

### Supplementary Note 10

The electrolysis cell according to any one of Supplementary Notes 1 to 9 may further include the housing (18, 18A) configured to cover the periphery of the stacked body and support the first current collector and the second current collector.

### Supplementary Note 11

In the electrolysis cell according to Supplementary Note 10, the stacked body may include the seal member (26) connected to both end portions of the diaphragm in the third direction, and the seal member may be configured to be in close contact with the housing to partition the inside of the housing into the first gas flow path communicating with the cathode and the second gas flow path communicating with the anode.

### Supplementary Note 12

In the electrolysis cell according to any one of Supplementary Notes 1 to 11, the third direction may be a vertical direction. According to this electrolysis cell, the gas can be quickly discharged from the inside of the housing.

### Supplementary Note 13

The electrolysis cell according to any one of Supplementary Notes 1 to 12 may further include the first auxiliary current collector (32) configured to abut on the outer peripheral side of a plurality of the first curved portions, and the second auxiliary current collector (34) configured to abut on the outer peripheral side of a plurality of the second curved portions. According to this electrolysis cell, the internal resistance can be reduced by shortening the length of the current path along the surface direction of the cathode or the anode. Further, the size can be easily increased by stacking a plurality of the electrolysis cells, and the electrolysis cell is therefore excellent in scalability.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. An electrolysis cell comprising:
a stacked body having a band shape and including a diaphragm including a first surface and a second surface, a cathode stacked on the first surface of the diaphragm, and an anode stacked on the second surface of the diaphragm, the stacked body meandering in a first direction and extending in a second direction;
a first current collector extending in a rod shape in a third direction perpendicular to the first direction and the second direction, and configured to abut on the cathode at a first curved portion where the stacked body is curved in a manner so that the first surface is located on an inner side; and
a second current collector extending in a rod shape in the third direction, and configured to abut on the anode at a second curved portion where the stacked body is curved in a manner so that the second surface is located on an inner side.

2. The electrolysis cell according to claim 1, wherein
the first current collector and the second current collector create a tension in the stacked body to bring the cathode and the anode into close contact with the diaphragm.

3. The electrolysis cell according to claim 1, wherein
the stacked body includes a straight portion extending between the first curved portion and the second curved portion adjacent to the first curved portion so as to be inclined with respect to the first direction and the second direction.

4. The electrolysis cell according to claim 1, wherein
the cathode and the anode are formed into a corrugated shape, and have rigidity to maintain the corrugated shape, and
the stacked body is compressed from both sides of the stacked body in the first direction to bring the cathode and the anode into close contact with the diaphragm by elastic forces of the cathode and the anode.

5. The electrolysis cell according to claim 4, wherein
the cathode and the anode come into close contact with the diaphragm by a tension caused by the first current collector and the second current collector in addition to the elastic forces of the cathode and the anode.

6. The electrolysis cell according to claim 4, wherein
the cathode and the anode each include expanded metal.

7. The electrolysis cell according to claim 1, wherein
the stacked body defines, on an inner side of the first curved portion, a first gas flow path through which a gas generated at the cathode passes, and defines, on an inner side of the second curved portion, a second gas flow path through which a gas generated at the anode passes.

8. The electrolysis cell according to claim 7, wherein
the first gas flow path and the second gas flow path each have a triangular cross section when viewed from the third direction.

9. The electrolysis cell according to claim 7, wherein
the cathode and the anode are each formed of meshed metal.

10. The electrolysis cell according to claim 1, further comprising a housing configured to cover a periphery of the stacked body and support the first current collector and the second current collector.

11. The electrolysis cell according to claim 10, wherein
the stacked body includes a seal member connected to both end portions of the diaphragm in the third direction, and the seal member is configured to be in close contact with the housing to partition an inside of the housing into a first gas flow path communicating with the cathode and a second gas flow path communicating with the anode.

12. The electrolysis cell according to claim 1, wherein
the third direction is a vertical direction.

13. The electrolysis cell according to claim 1, further comprising:
a first auxiliary current collector configured to abut on an outer peripheral side of a plurality of the first curved portions; and
a second auxiliary current collector configured to abut on an outer peripheral side of a plurality of the second curved portions.
